(19) United States
(12) Patent Application Publication
(10) Pub. No.: US 2025/0116534 A1
(43) Pub. Date: Apr. 10, 2025

(54) MEASUREMENT DEVICE FOR CURRENT COLLECTORS, AND METHOD FOR OPERATING THE MEASUREMENT DEVICE, AND A CALIBRATION APPARATUS

(71) Applicant: Paul Vahle GmbH & Co. KG, Kamen (DE)

(72) Inventors: Saman TORABZAD, Herne (DE); Florian NOLTE, Kamen (DE)

(21) Appl. No.: 18/687,139

(22) PCT Filed: Aug. 22, 2022
(86) PCT No.: PCT/EP2022/073304

§ 371 Date: Feb. 27, 2024

(30) Foreign Application Priority Data
Aug. 27, 2021 (DE) 10 2021 122 249.4

(51) Int. Cl. G01D 5/14; G01D 18/00

(52) U.S. Cl. CPC G01D 5/145; G01D 18/00

(57) ABSTRACT

A measuring device may be used to measure a position of at least one current collector arranged in an articulated manner on a current collector trolley of a current collector unit relative to the current collector trolley. The measuring device may include at least one sensor unit having at least one sensor and may be arranged on the current collector trolley. A permanent magnet may be arranged on at least one of the current collectors The at least one sensor may be a Hall sensor whose sensor signal may be used in determining a position of at least one of the current collectors, which may be fitted with permanent magnets.

The present invention relates to a measuring device for measuring a position of at least one current collector arranged in a jointed manner on a current collector trolley of a current collector unit relative to the current collector trolley, with at least one sensor unit having at least one sensor arranged on the current collector trolley. The invention also relates to a method for operating a measuring device according to the invention and a calibration device.

Current collector units for conductor rails are used in factory halls, warehouses or logistics centers, in particular to ensure a permanent electrical power supply to consumers along the track in conveyor systems such as electric monorail systems or electric monorail systems. Such current collector units usually have one or more current collectors that are jointed on a current collector trolley, whereby the current collectors usually have at least one current collector arm and one current collector contact. To ensure that the electrical power supply to the consumer is continuous, the current collector contacts must always be in contact with the conductor rail while the current collector units are moving. To achieve this, the conductor rail must be in as good a condition as possible and have as even a course as possible so that there are no sudden contact interruptions. Sudden contact interruptions can lead to operational failure and sometimes to enormous costs.

Intensive use causes wear and tear to both sliding contacts and conductor rails, which can have a negative impact on the continuous contact between the current collector contact and the conductor rail. Accidents, installation errors or improper use can also lead to faults, for example by deforming or destroying a conductor rail section or a current collector contact.

In order to be able to detect and eliminate such sources of error as early as possible, efforts are made to monitor the relevant systems over their entire length and as continuously as possible. There are different approaches to this. DE 202 05 710 U1 discloses a current collector unit in which a motion sensor is provided on a current collector, which detects the deflections of the current collector that occur due to irregularities in its conductor rail path. The movement sensor is a biaxial acceleration sensor that detects the acceleration exerted on the current collector or its movement and thus its deflection in two spatial dimensions.

DE102017008382A1 discloses a further current collector unit with an acceleration sensor, whereby the acceleration sensor detects changes in distance between a vehicle supplied with current and the conductor rails, which are caused by unevenness in the conductor rail. If the distance exceeds a defined tolerance value, a warning is issued by an evaluation unit, which evaluates the sensor signal and is located on the vehicle.

The measuring devices currently available on the market have the common disadvantage that the condition of a conductor rail can only be monitored relatively imprecisely. Due to the limitation to one or two spatial axes, complex three-dimensional movements in space, such as those caused by rotation and tilting of the current collector contacts, cannot be detected with sufficient accuracy.

The actual position of the current collectors relative to the current collector trolley can be described using various position parameters. Suitable position parameters can be, for example, the stroke and the deflection of the pantograph, whereby the stroke is essentially in the vertical direction, while the deflection describes the position of the pantograph in the horizontal plane. Since the deflection and the stroke together span a three-dimensional space, one- or two-axis sensors are not sufficient to describe the actual position of the current collectors. This is all the more true when the aforementioned tilting and rotation processes are taken into account. The uniaxial or biaxial acceleration sensors used to date can therefore only determine the actual position of the pantographs relatively roughly.

The task of the present invention is thus at least to provide a measuring device with which the position of the current collectors relative to the current collector trolley and thus the state of each corresponding conductor rail can be continuously monitored with great accuracy over the entire length of a system. The task of the invention is also to provide a method for operating a measuring device according to the invention as well as a calibration device.

At least one of the tasks is solved inventively by a measuring device with the features of claim 1 in that a permanent magnet is arranged on at least one current collector, and in that the at least one sensor is a Hall sensor, the measuring device determining the position of each current collector fitted with permanent magnets from at least one sensor signal (x, y, z) of the at least one Hall sensor.

At least one of the tasks is solved inventively by a method for operating a measuring device according to the invention with the features of claim 17 or by a calibration device with the features of claim 25.

With a measuring device according to the invention, it is possible to diagnose the conductor rail condition of a corresponding system, to check the assembly quality of newly built or repaired systems and to continuously monitor system wear with high accuracy.

The at least one sensor of the sensor unit is arranged in a fixed position on the current collector trolley in relation to the jointed current collector. This makes it possible to determine the position of the current collector relative to the current collector trolley in such a manner, that the sensor is detecting the magnetic field of the permanent magnet arranged on the current collector and measures the local change in the magnetic field induced by a change in the position of the current collector.

In a preferred embodiment of the measuring device according to the invention, at least one permanent magnet is arranged on at least one, in particular all, current collector(s). With an equal number of sensors, each sensor can then, for example, determine the position of a current collector. Of course, it can also be advantageous if more than one permanent magnet is arranged on a current collector, for example to generate a special advantageous magnetic field, or to determine the position of a current collector using two different sensors.

In a particularly preferred embodiment of the measuring device according to the invention, at least one sensor is a 3D Hall sensor. It is then possible for the measuring device to determine the position of each current collector fitted with permanent magnets in all three spatial directions. The Infineon TLV493D-A1B6, for example, has proven to be particularly suitable as it can also detect complex rotations, tilts and translations in space. The 3D Hall sensor continuously outputs three sensor signals that allow conclusions to be drawn about the spatial change in the detected magnetic field. Neodymium magnets are particularly suitable as permanent magnets.

In a further embodiment, the at least one sensor is arranged on at least one printed circuit board. In the case of several sensors, all sensors can be arranged on a common printed circuit board, so that the sensor unit can essentially consist of a compact sensor module. The sensor unit can have a housing that is arranged on the current collector trolley. The at least one sensor is then arranged in the housing, which is positioned in such a way that the at least one sensor can detect the magnetic field of the at least one permanent magnet.

Depending on the design, it can be advantageous if each permanent magnet has a different remanence, a different magnetic field strength, a different magnetization and/or a different position on the current collector compared to an adjacent permanent magnet. Since the current collectors of conventional current collector units are usually arranged close to each other, the magnetic fields of neighboring permanent magnets can influence or overlap each other, so that it can be problematic for a sensor to specifically detect the corresponding permanent magnet. By using different values, a sensor can be specifically tuned to detect exactly one corresponding permanent magnet.

In another possible embodiment, it may alternatively or additionally be advantageous to arrange the permanent magnets as far apart as possible despite the limited space available. Since the spacing of permanent magnets of neighboring current collectors in a spatial direction is determined by the spacing of the current collectors, it can be advantageous if the permanent magnets of neighboring current collectors are arranged at different distances from the respective bearing of the current collectors. This can result in a staggered zigzag arrangement of the permanent magnets, for example, so that the magnetic fields of neighboring permanent magnets influence each other as little as possible. The attachment point is the point or joint at which the current collector is hingedly attached or suspended to the current collector trolley.

In another possible embodiment of the measuring device, neighboring sensors each have a different distance to the bearing axis of the current collectors.

In another possible and preferred embodiment, the permanent magnets and the corresponding sensors are opposite each other in a zero position of the current collectors.

Of course, it is also in the spirit of the invention if the above-described embodiments of the invention are taken together in a combination embodiment or if their respective advantages are combined with one another.

At least one magnet holder that holds at least one permanent magnet can be arranged on at least one current collector. The magnet holder can, for example, be made partly or entirely of metal or a special shielding plastic, which can advantageously reduce the interaction between neighboring permanent magnets, in particular by aligning or specifically bundling and shaping the magnetic fields of the individual permanent magnets. Alternatively or additionally, at least one permanent magnet can be attached to a current collector or integrated into it in a visible or invisible manner. The external shape of the permanent magnets can also influence the shape of their external magnetic field, which also makes it possible to reduce the interaction of the individual magnetic fields of the permanent magnets.

In order to identify the current collector or the permanent magnet arranged on it or the sensor and thus ensure a correct assignment of permanent magnet and sensor, an RFID transponder can be arranged on the current collector or a magnet holder. After installation or during maintenance, it can then be determined whether the assignment of sensor and permanent magnet has been carried out correctly.

In a further embodiment, the measuring device has a readout device and/or a communication device for outputting the at least one sensor signal or for transmitting the at least one sensor signal to a data processing device. The readout device can be a USB port, an SD card slot or any other suitable interface, for example. The communication device can be, for example, a radio transmitter, a Bluetooth® transmitter or any other suitable wireless or wired transmission option to a data processing device. In this case, the data processing device can use the at least one sensor signal to determine the position of the at least one current collector.

The measuring device according to the invention can advantageously be designed in such a way that it can be attached to existing current collector units, so that existing systems can be equipped or retrofitted with a measuring device according to the invention. Of course, it is also conceivable to equip a current collector unit ex works with a measuring device according to the invention.

In the method according to the invention for operating a measuring device according to the invention, the current collectors are moved simultaneously or individually to different positions or adjusted by means of an adjusting device in order to calibrate the measuring device. For each position, the sensor signals measured by the sensors are determined and assigned to the respective position. By means of data processing, this data and/or values or curves and/or sets of curves calculated from it, in particular correlated values, are stored in a knowledge database.

In a preferred embodiment, the actual position of at least one, preferably all, current collectors is calculated during normal operation or test operation of the current collector unit on the basis of the sensor signals or values determined by means of the sensor unit using the data from the knowledge database determined and evaluated during calibration.

During calibration, different positions of the at least one current collector are thus generated by varying different position parameters such as stroke and lateral deflection transverse to the direction of travel. This is done systematically, with at least one position parameter being kept constant and at least one other position parameter being systematically varied, with the at least one sensor signal being determined for each position generated in this way and assigned to the respective position.

In a further embodiment, depending on the sensor, it may be the case that at least one sensor generates more than one sensor signal. In this case, a data processing device links the multiple sensor signals of the at least one sensor with one another and thus determines a new value, so that the at least one new value can be assigned to a combination of position parameters and thus to precisely one position of at least one current collector.

In the case of 3D Hall sensors, for example, each sensor outputs three sensor signals x, y, z. The sensor signals x, y, z can then be assigned to a corresponding combination of position parameters, i.e. present in the respective position P, such as a stroke and deflection value H, A, for example. With several sensor signals, however, depending on the configuration or arrangement of the sensors, their spatial alignment and/or the type of position measured, a higher sensor signal value does not necessarily mean a higher stroke or greater deflection. It is possible, for example, that although a positive stroke is present, the sensor signal or sensor signals are influenced by a simultaneous tilting or rotation of the current collector in such a way that no direct linear or monotonic relationship between the measured sensor signal and the effective stroke is recognizable. Furthermore, with several, in particular three spatial, sensor signals, it is not possible to define a clear distance to other sensor signals without further calculations, in particular vector calculations. Therefore, a method must be found that makes it possible to establish a monotonic relationship between the sensor signals and the current collector movements.

By way of example, a set of sensor signals x, y, z can be systematically determined at different positions P=(H, A) if a set of stroke values H={−15 mm, −12.5 mm, −10 mm, . . . , 10 mm, 12.5 mm, 15 mm} is generated for each (lateral) deflection value A={−15 mm, −7.5 mm, 0, 7.5 mm, 15 mm} and the corresponding sensor signals x, y, z are recorded and stored in a knowledge database. Of course, any number of other combinations of stroke and deflection values, other grid settings or even completely different position parameters can be just as useful or advantageous depending on the operating range of the current collector.

In the example above, this results in a (13×5) matrix (13 stroke values, 5 deflection values) with 65 combinations of stroke and deflection values, each corresponding to exactly one position P=(H,A) of one or all current collectors. The sensor signals x, y, z that can be assigned to these positions P are stored in the knowledge database as entries in the matrix.

In the above example, two new values D_{H} and D_{A} can be determined for each of the 65 positions P=(H, A), for example, which link the sensor signals associated with each position P in different ways. In practice, the links D_{A}=√(x²+y²+z²) and D_{H}=y/z have proven to be suitable for the above example, as they provide monotonically increasing values for a fixed A or a fixed H (i.e. along a row or a column in the above (13×5) matrix). Of course, other combinations may be useful or necessary for other sensors or position parameters, which must always be determined anew in each individual case.

In a particularly preferred embodiment of the method, the data processing device determines at least one, in particular continuous, mathematical function which at least approximately calculates the corresponding position parameters of the different position parameters of the different positions by inserting the new values into the function.

In principle, the determined function can be any suitable mathematical function, such as a rational or polynomial function, which calculates the values of the deflection parameters using the previously calculated new values or approximates them with sufficient accuracy.

In a particularly preferred embodiment of the method, exactly one mathematical function is determined for each constant value of a position parameter H, A during the simulation (i.e. for each column and each row of the matrix of the above example) in such a way that the corresponding other position parameter can be determined for a given position parameter (i.e. for each column and each row of the matrix of the above example) using the new value.

In the above example, for example, rational functions (sets) f_{H}, f_{A} can be determined which, by inserting the new values D_{A}, D_{H} into the corresponding function, provide the stroke H or the lateral deflection A transverse to the direction of travel for a fixed A or a fixed H (i.e. along a row or a column in the above (13×5) matrix) at least as a good approximation, whereby the functions f_{H} provide the deflection A for a fixed H by inserting the values D_{A} and the functions f_{A} provide the stroke for a fixed A by inserting the values D_{H}. In this way, the values for A of each column are calculated or approximated by a function f_{H} and the values H of each row by a function f_{A}. In this example, this results in a total of 18 functions (5 f_{A} and 13 f_{H}), which cover the entire position space P=(H, A) like a grid.

Due to the grid-like covering of the entire position space, a smallest distance Q between at least one sensor signal measured in normal operation or in test operation and the values of the at least one sensor signal determined during calibration can be determined in normal operation or in test operation and assigned to the corresponding position, so that the position parameters of the actual ACTUAL position of at least one or all current collectors can be calculated or approximated for the new values determined in normal operation or in test operation using the corresponding functions.

In the above example, this means that for the sensor signals x_{R}, y_{R}, z_{R} measured in normal operation or in test operation, the closest sensor signals x, y, z determined during calibration and stored in the knowledge database are determined by means of vector calculation, whereby the closest sensor signals x, y, z are assigned to a specific position P. Two intersecting functions f, f are assigned to this position. Two intersecting functions f_{H}, f_{A} are assigned to this position, into which the new values D_{HR}, D_{AR} measured in normal operation are inserted and thus the corresponding position parameters H_{R}, A_{R} of the actual position P_{R} in normal operation or in test operation can be determined. In this way, the position P_{R} of the current collectors can be determined continuously and over the entire course of the system.

These 65 combinations mentioned above result when all current collectors are raised and deflected step by step by means of the calibration device. If the calibration device does not deflect the current collectors together but individually and provides a number of AZ lateral deflections A and a number of HZ strokes H for each current collector, a number of SZ current collectors (AZ x HZ)\hat{ }SZ would result in different combinations or positions P=(SZ, H, A), and thus a three-dimensional matrix from which the other values and functions are then determined and calculated. The number of different stroke positions and deflections must be selected accordingly so that the calibration process does not take too long. In addition, certain positions of the current collectors in relation to each other are not relevant for the derivation of the functions, as, for example, the magnetic fields of current collectors that are further apart have no influence on each other.

In a particularly preferred embodiment of the method, calibration is partially or fully automatic. At least one of the calibration steps described above can be performed automatically. Advantageously, all calibration steps can be performed automatically. For example, at least one current collector can be automatically moved to the various positions P intended for calibration and/or the sensor signals x, y, z measured at these positions can be automatically stored and/or the mathematical functions f_{H}, f_{A} can be automatically determined and/or the new values D_{H}, D_{A} can be automatically determined.

In the above example, all current collectors can thus preferably be automatically brought into all of the previously defined 13×5=65 positions, whereby the sensor signals x, y, z are automatically measured at each position and stored in the data processing device. The data processing device can then determine and store the new values D_{H}, D_{A} and the mathematical functions f_{H}, f_{A} fully automatically, so that the current collector unit is then fully calibrated and can be put into operation. In this way, calibration can be carried out very easily and reliably. Of course, the corresponding program routines must first be defined in the data processing.

Fully automatic calibration is particularly suitable if, as described above, the current collectors are also brought into different positions in relation to each other by means of the calibration device and the numerous measured values determined in the process are processed.

It can also be advantageous if only one or some of the calibration steps are carried out automatically. This can be the case, for example, if current collector units of different designs are to be calibrated with the same calibration device. It may then be that the matrix of positions suitable for one current collector unit is unsuitable for another current collector unit. In this case, it can be advantageous if the corresponding matrix must/can be selected by a user beforehand. The subsequent measurement of the sensor signals x, y, z and/or the determination of the mathematical functions f_{H}, f_{A} and the new values D_{H}, D_{A} can then take place automatically depending on the selected matrix.

In one embodiment of the method, calibration is carried out by running a well-defined section of a conductor rail. This has the practical advantage that the calibration can be repeatedly checked and, if necessary, corrected during test operation without dismantling.

In a further embodiment of the invention, the different positions of the current collectors are set using a calibration device specially provided for this purpose.

A suitable calibration device for carrying out a method according to the invention has at least one well-defined section of a conductor rail, at least one current collector, at least one traversing device for adjusting the current collectors, in particular the stroke and the lateral deflection transverse to the direction of travel, at least one electronic control unit for controlling the at least one traversing device and for transmitting the at least one sensor signal to at least one data processing device, which determines the new values and the at least one mathematical function on the basis of the at least one sensor signal and the known position parameters.

Of course, with the method or the calibration device according to the invention, it is basically possible to adjust and calibrate either all current collectors simultaneously or one, in particular each, current collector individually relative to the others. When calibrating individual current collectors, the other current collectors or even just the adjacent current collector(s) can be moved to previously defined positions for each position of the current collector to be calibrated, so that the different reciprocal influence of the magnetic fields of the permanent magnets that exists when the current collectors are in different positions relative to each other is included in the calibration. For example, it may be advantageous to calibrate exactly two adjacent current collectors individually by calibrating the current collector to be calibrated using the position parameters as described above, whereby at least one further position parameter is linked to the position of the current collector to be calibrated, which corresponds to the position of the other, in particular the adjacent, current collector(s). In normal or test operation, this at least one further position parameter is then taken into account in the measurement. In this case, it may be sufficient if only different strokes or lateral deflections of the individual current collectors relative to each other are additionally taken into account. As a rule, however, it makes sense to take into account both the different strokes and the different deflections of at least neighboring current collectors so that the different strokes and/or deflections can also be reliably detected afterwards.

A suitable calibration device therefore has a suitable traversing device or several traversing devices that enable the current collectors to be adjusted independently of each other. With a current collector unit calibrated in this way, an even more accurate measurement is conceivable. This applies in particular if the current collector contacts are not worn evenly or if only one phase of the conductor rail is dirty or particularly dirty.

In the following, the invention is explained with reference to figures in which some embodiments of the diagnostic arrangement according to the invention and a calibration device are shown.

It shows:

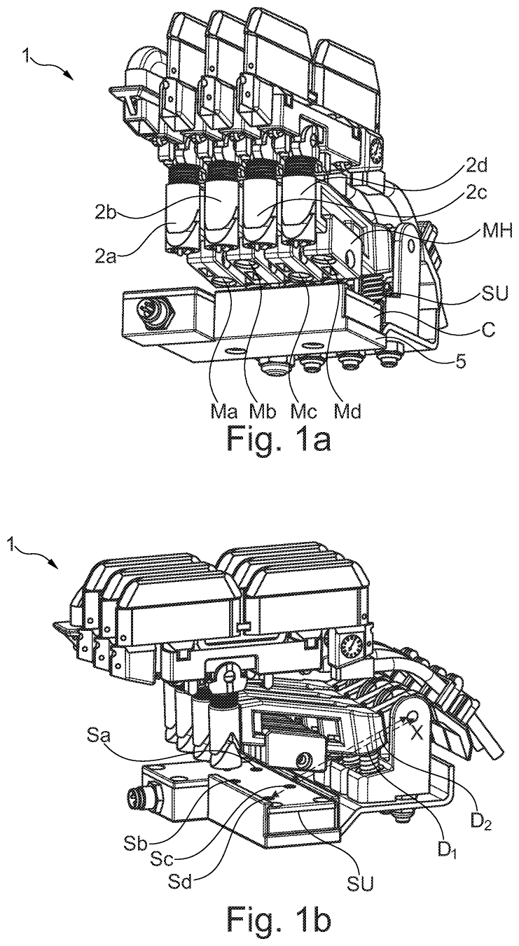

FIG. 1a a current collector unit with four current collectors and a current collector trolley, not shown, and a measuring device according to the invention, wherein a magnet holder with a permanent magnet is arranged on each current collector;

FIG. 1b the same current collector unit with a visible sensor unit with four 3D Hall sensors;

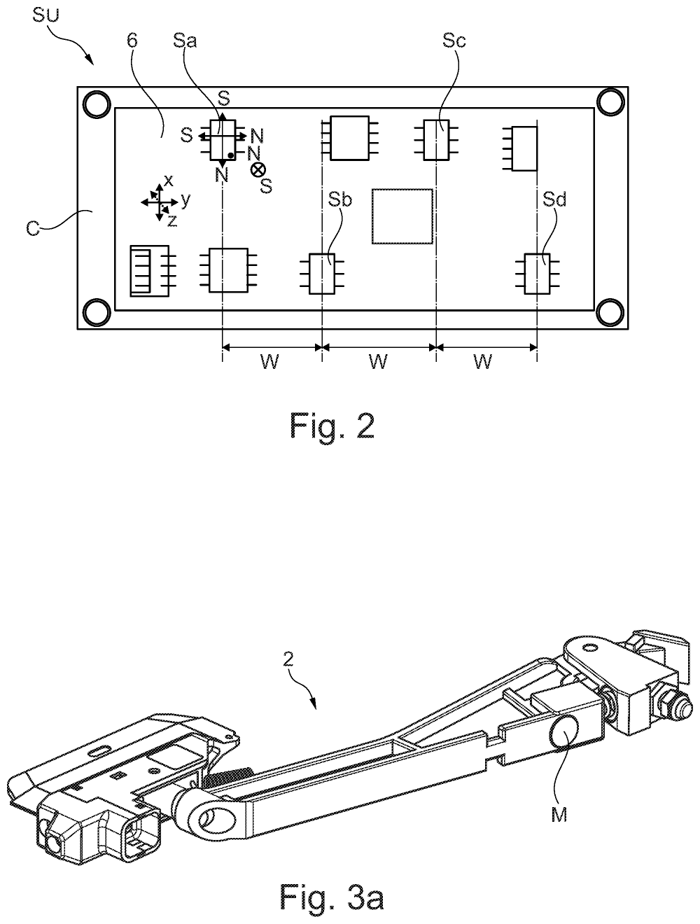

FIG. 2 a schematic representation of a printed circuit board of a sensor module with four 3D Hall sensors;

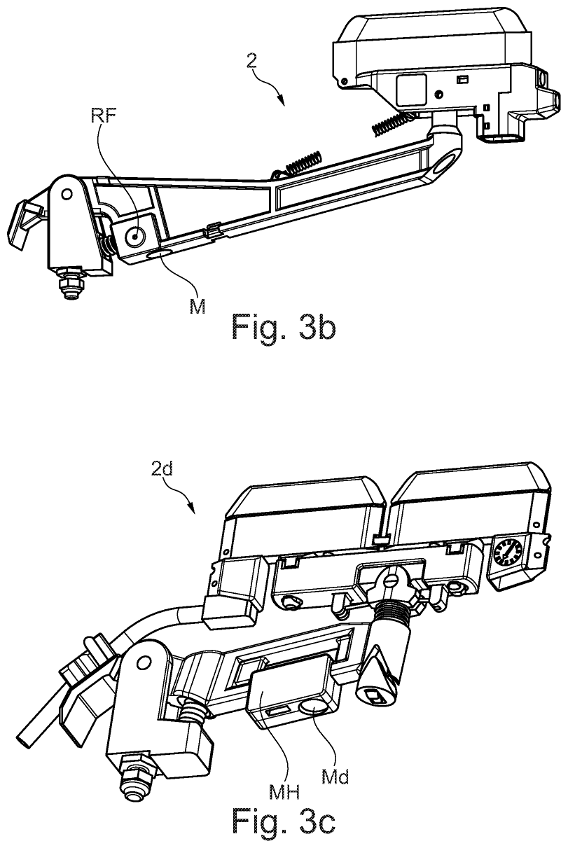

FIG. 3a a current collector with integrated permanent magnet;

FIG. 3b a current collector with an RFID sensor arranged on the current collector;

FIG. 3c a current collector arm with a permanent magnet held by a magnet holder;

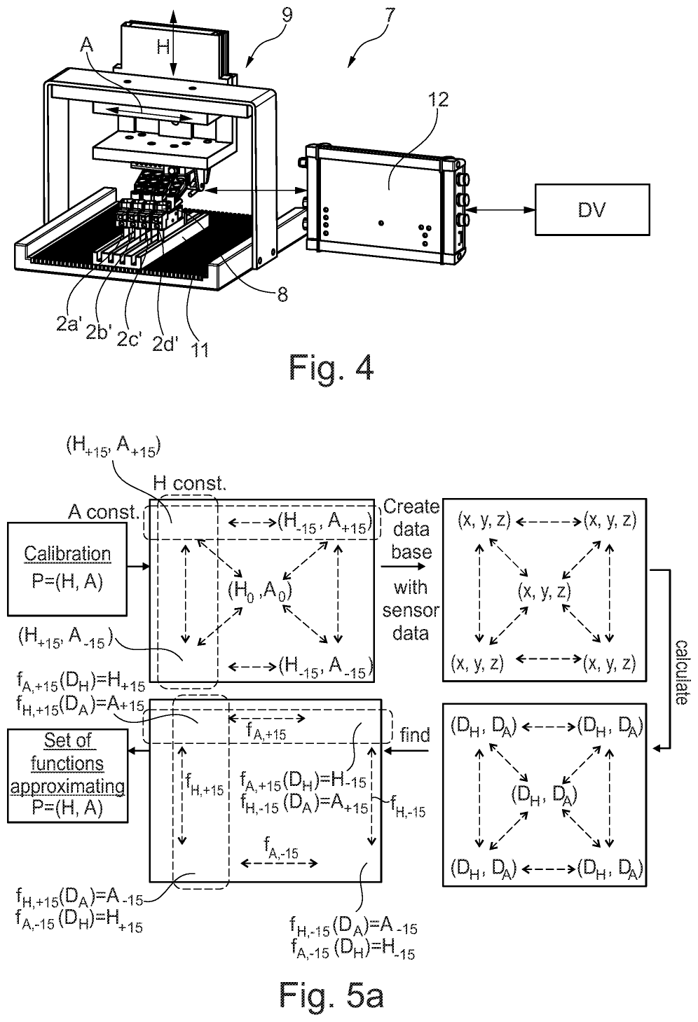

FIG. 4 a calibration device according to the invention;

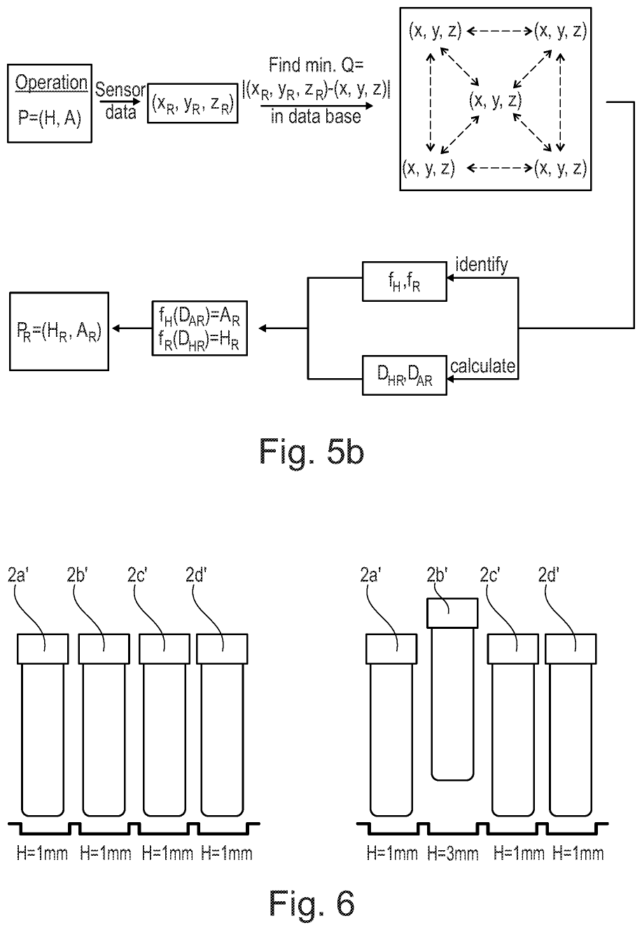

FIG. 5a a process diagram for calibrating the measuring device according to the invention;

FIG. 5 is a process diagram for determining an actual position during normal or test operation of a measuring device according to the invention;

FIG. 6 two different configurations of current collector sliding contacts.

FIG. 1a shows a current collector unit 1 with four current collectors 2a, 2b, 2c, 2d which are hinged to a current collector trolley not shown. A magnet holder MH is arranged on each current collector 2a, 2b, 2c, 2d and holds a permanent magnet Ma, Mb, Mc, Md. A sensor unit SU with a housing C is arranged opposite the permanent magnets Ma, Mb, Mc, Md, whereby the housing C is attached to a base plate 5 of the current collector trolley.

FIG. 1b shows the same current collector unit 1 from a different perspective. The sensor unit SU has four sensors Sa, Sb, Sc, Sd in the form of 3D Hall sensors arranged opposite the permanent magnets Ma, Mb, Mc, Md, with neighboring sensors Sa, Sb, Sc, Sd and neighboring permanent magnets Ma, Mb, Mc, Md each being arranged at a different distance D₁, D₂ from a bearing or a bearing axis X of the corresponding current collector 2a, 2b, 2c, 2d. FIG. 2 shows a circuit board 6 of the sensor unit SU with the four sensors Sa, Sb, Sc, Sd arranged on it. The arrangement of the sensors Sa, Sb, Sc, Sd corresponds to a mirrored arrangement of the opposing permanent magnets Ma, Mb, Mc, Md, which are not shown, so that the sensors Sa, Sb, Sc, Sd in a zero position of the current collectors 2a, 2b, 2c, 2d are as close as possible to the corresponding permanent magnets Ma, Mb, Mc, Md and the permanent magnets Ma, Mb, Mc, Md are simultaneously arranged as far apart as possible so that the interaction of the magnetic fields of the individual permanent magnets Ma, Mb, Mc, Md is minimized. The circuit board 6 is arranged in the housing C, which is attached to the base plate 5 of the current collector trolley.

In the example shown in FIG. 2, the sensors Sa, Sb, Sc, Sd are 3D Hall sensors of the type Infineon TLV493D-A1B6. The x-, y- and z-axes are drawn according to the manufacturer's data sheet and the corresponding north and south poles are marked. In this example, the x- and y-axes detect the magnetic field within the image plane, while the z-axis detects the magnetic field or its change along the surface normal of the image plane. The south pole of the z-axis is closer to a viewer, the north pole is correspondingly further away from the viewer.

In the y-direction, the sensors Sa, Sb, Sc, Sd are at a distance W from each other, which essentially corresponds to the distance between the current collectors and thus the distance between the phases of the conductor rail. In the example shown, the distance W is 14 mm. In the x-direction, the sensors Sa, Sb, Sc, Sd are spaced as far apart as possible in accordance with the size of the card and are therefore essentially arranged at the top or bottom edge of the circuit board 6.

FIG. 3a shows a current collector 2 with a permanent magnet M incorporated therein. FIG. 3b shows the same current collector 2 with the permanent magnet M incorporated therein and an RFID transponder RF arranged next to it to identify the permanent magnet M. FIG. 3c shows a single view of the current collector 2d with the magnet holder MH and the permanent magnets Md held by it.

FIG. 4 shows a calibration device 7 according to the invention with a current collector system 8 with four current collectors 2a′, 2b′, 2c′, 2d′, which are arranged on a traversing device 9. The traversing device 9 simulates different positions using a well-defined section 11 of a conductor rail by varying two position parameters H, A, which in the example shown correspond to stroke and deflection. An electronic control unit 12 is used on the one hand to control the traversing device 9 and on the other hand to transmit the measured sensor signals x, y, z to a data processing device DV. The data processing DV then determines the necessary values D_{H}, D_{A} and functions f_{H}, f_{A} for calibration and subsequent normal operation in accordance with the above description of the method according to the invention.

It is of course also possible that preferably at least the stroke and, if necessary, also the deflection for each current collector can be adjusted or set individually with a corresponding calibration device, whereby the calibration and subsequent determination of the deflection and in particular the stroke can then be carried out with greater accuracy due to the even more precise or higher-resolution previously determined functions.

FIG. 5a shows a process diagram for the calibration of a measuring device according to the invention as described above, using an example with position parameters stroke H and deflection A. During calibration, different positions P=(H, A) are systematically generated by keeping one position parameter H, A constant and adjusting the other position parameter H, A step by step. This results in a matrix with a large number of positions P or position parameter combinations H, A, where each row corresponds to a constant deflection and each column corresponds to a constant stroke. The maximum values for stroke and deflection (±15 mm) are selected in accordance with the example above and are for illustrative purposes only.

For each position contained in the matrix, the sensor signals x, y, z are determined and stored in a corresponding matrix in a data processing device. In this way, a knowledge database is generated on the basis of the positions shown during calibration, whereby the entries x, y, z can be assigned to exactly one position P in each case. For the sake of clarity, the entries are all labeled x, y, z. Of course, the values of the individual matrix elements can and should differ from one another.

Based on this matrix with sensor signals x, y, z, the data processing device calculates the new values D_{H}, D_{A}, for example using the above linking rules. This creates a further matrix in the knowledge database, whereby each matrix element contains a new value D_{H} and a new value D_{A}. Each combination of new values D_{H}, D_{A} can therefore be assigned to exactly one position P.

In the next step, the data processing device determines a function f_{H}, f_{A} for each row and each column of the matrix. The functions must fulfill the property f_{A} (D_{H})≈H or f_{H} (D_{A})≈A, so that for a fixed position parameter H, A exactly one function determines all values of the other position parameter H, A if the new value D_{H}, D_{A} present in the matrix element is inserted into the function f_{H}, f_{A}. However, the functions or sets of functions may not be exclusively rational functions or polynomial functions, for example, depending on the desired accuracy and the permissible computational effort. This ultimately results in a set of several functions or sets of functions that cover the position space P=(H, A) in a grid-like manner and thus describe it approximately.

FIG. 5b shows a process diagram for determining the ACTUAL position during normal or test operation of a measuring device according to the invention. During normal or test operation, the current collector(s) are moved along a conductor rail. The actual ACTUAL position P_{R} is initially unknown. The sensors supply a set of sensor signals x_{R}, y_{R}, z_{R} for each position P=(H, A).

The data processing device then uses vector calculation in the matrix from the knowledge database with the sensor signals x, y, z determined during calibration to search for the matrix element with the smallest distance Q to the sensor signals x_{R}, y_{R}, z_{R} measured during normal or test operation. The data processing device uses these sensor signals x_{R}, y_{R}, z_{R} to calculate the new values D_{HR}, D_{AR}. Since exactly two functions f_{H}, f_{A} are assigned to the determined matrix element with the smallest distance in the knowledge database, the data processing device can use these functions f_{H}, f_{A} to calculate or approximate the actual position parameters H_{R}, A_{R} in normal or test operation by inserting the new values D_{HR}, D_{AR}. Thus, the actual position P_{R}=(H_{R}, A_{R}) can be continuously determined during normal or test operation by means of the measuring device according to the invention.

FIG. 6 shows two different configurations of the current collectors 2a′, 2b′, 2c′, 2d′. In both configurations, the sliding contact of the current collector 2a′ is in the same position (H=1 mm). However, due to a different position of the sliding contact of the current collector 2b′ in each case, the interaction between the corresponding permanent magnets can be different, such that the sensor signals of the sensor corresponding to the current collector 2a′ differ from one another to a non-negligible extent despite the same position (H=1 mm). Therefore, depending on the embodiment, it may be advantageous if at least one additional position parameter is taken into account and recorded during calibration, which contains information about the position of at least one other, in particular neighboring, current collector. The corresponding current collectors can then be calibrated individually for different positions of at least one other current collector, whereby a corresponding calibration device has a suitable traversing device or traversing devices and correspondingly adapted software.

1. A measuring device for measuring a position of at least one current collector arranged in an jointed manner on a current collector trolley of a current collector unit relative to the current collector trolley, the measuring device including:
at least one sensor unit which has at least one sensor and is arranged on the current collector trolley,
wherein at least one permanent magnet is arranged on at least one of the at least one current collector, and wherein at least one of the at least one sensor is a Hall sensor,
wherein the measuring device is enabled to derive the position of a respective one of the at least one current collector having a respective one of the at least one permanent magnet based on at least one sensor signal of the at least one Hall sensor.

2. The measuring device according to claim 1, wherein one or more respective permanent magnets of the at least one permanent magnet is or are arranged on respective ones of the at least one current collector.

3. The measuring device according to claim 1, wherein the at least one sensor is a 3D Hall sensor, and wherein the measuring device is enabled to determine the position of each of the at least one current collector fitted with one or more of the at least one permanent magnet in all three spatial directions.

4. The measuring device according to claim 1, wherein at least one of the at least one permanent magnet is a neodymium magnet.

5. The measuring device according to claim 1, wherein the at least one sensor is arranged on at least one printed circuit board.

6. The measuring device according to claim 1, wherein the sensor unit has a housing which is arranged on the current collector trolley.

7. The measuring device according to claim 1, wherein each respective one of the at least one permanent magnet has a different remanence, different magnetic field strength and/or different magnetization with respect to an adjacent one of the at least one permanent magnet.

8. The measuring device according to claim 2, wherein the one or more respective permanent magnets of adjacent respective ones of the at least one current collector are each arranged at different distances from respective bearings of the adjacent ones of the at least one current collector.

9. The measuring device according to claim 1, wherein adjacent ones of the at least one sensor have different distances from a bearing axis of the at least one current collector.

10. The measuring device according to claim 1, wherein one the at least one permanent magnet and the at least one sensor is or are arranged opposite one another.

11. The measuring device according to claim 1, wherein at least one magnet holder is arranged on at least one of the at least one current collector and holds at least one of the at least one permanent magnet.

12. The measuring device according to claim 1, wherein at least one of the at least one permanent magnet is attached to or integrated into at least one of the at least one current collector.

13. The measuring device according to claim 1, wherein at least one RFID transponder for identifying a respective one of the at least one permanent magnet and/or a respective corresponding sensor of the at least one sensor, wherein the RFID transponder is arranged either on the at least one current collector or on a magnet holder.

14. The measuring device according to claim 1, further including a readout device and/or a communication device adapted to output the at least one sensor signal or to transmit the at least one sensor signal to a data processing device.

15. The measuring device according to claim 14, wherein the data processing device is configured to use the at least one sensor signal to determine the position of the at least one current collector.

16. A current collector unit including the measuring device according to claim 1.

17. A method of operating the measuring device according to claim 1, the method including: calibrating the measuring device by simultaneously or individually bringing individual ones of the at least one current collector into different positions or employing an adjusting device to together or individually set strokes and/or deflections of the individual ones of the at least one current collector to result in different positions determining sensor signals corresponding to the different positions, and calculating, using a data processing device, data and/or values and/or curves and/or sets of curves corresponding to correlated values, and storing the data and/or values and/or curves and/or sets of curves in a knowledge database, resulting in data of the knowledge database.

18. The method according to claim 17, further including calculating an actual position of one or more of the at least one current collector using the data of the knowledge database determined and evaluated during calibration in normal operation or test operation of the one or more of the at least one current collector on the basis of sensor signals or values determined by the at least one sensor.

19. The method according to claim 18, wherein calculating the actual position of one or more of the at least one current collector further includes generating by the at least one sensor more than one sensor signal, thus resulting in several sensor signals, and using the data processing device to link the several sensor signals of the at least one sensor and to determine a new value that is assigned to a combination of position parameters and thus to precisely one position of the at least one current collector.

20. The method according to claim 19, wherein the data processing device determines at least one continuous mathematical function which at least approximately calculates corresponding position parameters of different positions by inserting the new values into the mathematical function.

21. The method according to claim 19, wherein for each constant value of a position parameter during calibration, precisely one mathematical function is determined in such a way that a corresponding other position parameter is determinable for a given position parameter using the new value.

22. The method according to claim 21, wherein in normal operation or in test operation, a smallest distance between at least one sensor signal measured in normal operation or in test operation and the sensor signals determined during calibration and assigned to a particular position is determined, so that position parameters of an actual position of at least one of the at least one current collector is enabled to be calculated or approximated for the new values determined in normal operation or in test operation using the at least one continuous mathematical function corresponding to the particular position.

23. The method according to claim 17, wherein at least one of the at least one current collector is individually adjusted and calibrated.

24. The method according to claim 23, wherein a position of the at least one of the at least one current collector that is individually calibrated is linked to a position of at least one other current collector of the at least one current collector.

25. The method according to claim 19, wherein the calibrating is partially or fully automatic, in that all of the at least one current collector(s) is/are automatically brought into the different positions and/or the sensor signals are automatically measured and stored and/or the mathematical functions is automatically determined and/or the new values is automatically determined.

26. The method according to claim 17, wherein the calibrating is carried out by traversing a section of a conductor rail.

27. The method according to claim 17, further including simulating different positions using a calibration device.

28. A calibration device configured to be used in the method according to claim 27, including: at least one well-defined section of a conductor rail, at least one current collector, at least one traversing device configured to adjust stroke and lateral deflection with respect to a direction of travel along the conductor rail of the at least one current collector, at least one electronic control unit to control the at least one displacement device and to transmit at least one sensor signal to at least one data processing device configured to use the at least one sensor signal and the stroke and lateral deflection to determine new values and at least one mathematical function.

29. The calibration device according to claim 28, wherein the displacement device is capable of displacing at least one of the at least one current collector individually, or wherein several displacement devices are provided.
